(19) United States
(12) Patent Application Publication
(10) Pub. No.: US 2019/0132319 A1
(43) Pub. Date: May 2, 2019

(54) SYSTEM AND METHOD FOR AUTHENTICATING OUTSIDE PARTIES FOR COMMUNICATION WITH INMATES OF A CONTROLLED ENVIRONMENT

(71) Applicant: Global Tel*Link Corporation, Reston, VA (US)

(72) Inventor: Stephen HODGE, Aubrey, TX (US)

(73) Assignee: Global Tel*Link Corporation, Reston, VA (US)

(21) Appl. No.: 15/794,469

(22) Filed: Oct. 26, 2017

(51) Int. Cl. H04L 29/06

(52) U.S. Cl. CPC H04L 63/101; H04L 63/06; H04L 63/20

(57) ABSTRACT

A system and method are disclosed for registering outside parties for communications inmates, and for processing communications between the inmates and outside parties. In order for an outside party to be approved for any particular communication with an inmate, the outside party is subjected to the approval of the jurisdiction. In this regard, a registration system identifies the relevant jurisdiction and applies one or more rules associated with the jurisdiction to information obtained regarding the outside party. Based on the analysis, the outside party is registered in a database along with an approval indication for all jurisdictions and inmates for which a registration has been performed. For later calls, the registration database can be quickly accessed to determine whether a given communication is authorized.

### TECHNICAL FIELD

The disclosure relates to systems and methods for identifying and authenticating outside parties for purposes of communicating with inmates of a resident of a controlled-environment facility.

### BACKGROUND

In controlled environments, such as prisons for example, member (hereinafter “inmate”) communications with individuals outside the controlled environment are carefully regulated and monitored. In order for inmates to communicate with outside parties, those outside parties often must first be approved. However, this approval process is typically carried out generally for all jurisdictions, or requires individual review by each facility.

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates a block diagram of an exemplary calling environment.

FIG. 2 illustrates a block diagram of an exemplary embodiment of a centralized controlled communication system (CCS).

FIG. 3 illustrates an exemplary database structure of a registration database according to an embodiment of the present disclosure.

FIG. 4 illustrates a flowchart diagram of an exemplary method for processing a call according to an exemplary embodiment of the present disclosure.

FIG. 5 illustrates a flowchart diagram of an exemplary method for determining whether an outside party is approved for the particular communication, according to an embodiment of the present disclosure.

FIG. 6 illustrates an exemplary method for carrying out a registration of an outside party according to an embodiment of the disclosure.

FIG. 7 illustrates a block diagram of an exemplary computer system for carrying out the methods of FIGS. 4-6, according to embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Although the description below is made with respect to a prison facility or other controlled environment, the disclosed systems and methods can be used in any communication environment.

### Inmate Calling Environment

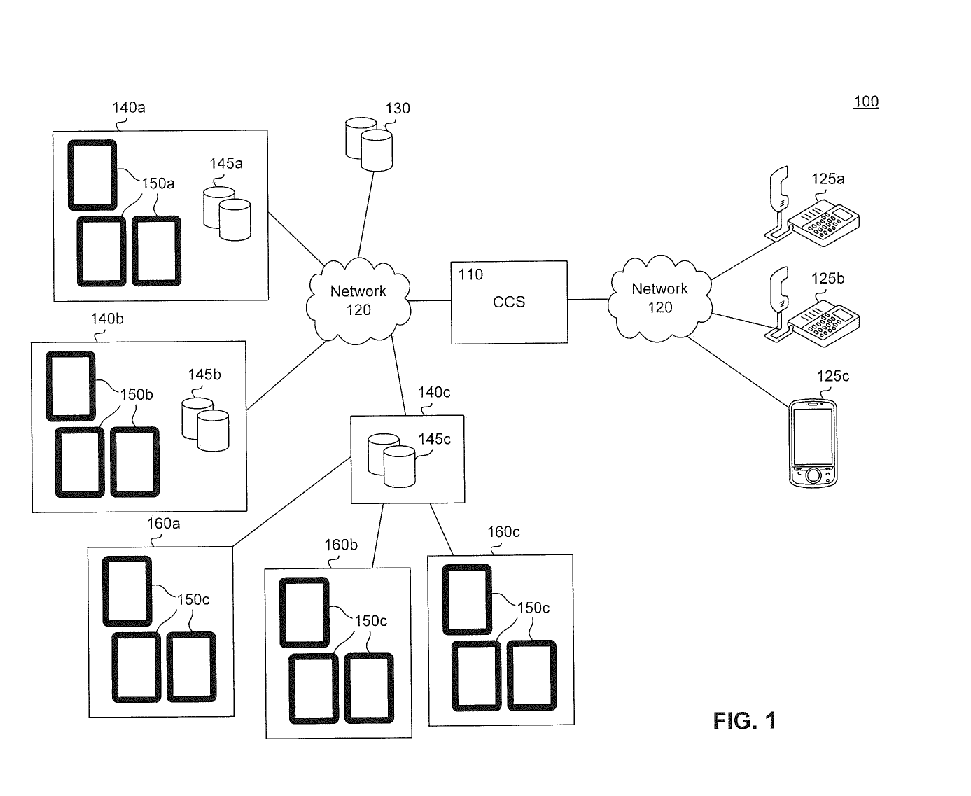

FIG. 1 illustrates a block diagram of an exemplary calling environment 100. In the environment 100, a Central Call Processing System (CCS) 110 functions as a centralized call processing server. The CCS 110 is responsible for receiving and distributing call data between inmates and outside parties as well as other functions, such as authentication, authorization, call recording, etc.

The CCS 110 is connected to a plurality of outside party telecommunication devices 125 via a network 120. The telecommunication devices 125 include any devices capable of effectively communicating via an authorized method of communication with the CCS, such as telephones, tablets, email, etc.

The CCS 110 is also connected to a plurality of correctional jurisdictions 140 via the network 120. Each jurisdiction may be a state, county, municipal, or other regional correctional system. Each jurisdiction includes one or more databases 145. Such databases may include criminal databases, authorization databases, or other databases for use in the authorization and authentication of outside parties.

Some jurisdictions may include direct communication with inmate calling devices 150, such as devices 150a and 150b in jurisdictions 140a and 140b, respectively. However, some other jurisdictions, such as jurisdiction 140c, may provide pass-through communications to correctional facilities 160a-160c within the jurisdiction. Each of those facilities 160 includes the inmate devices 150.

The CCS 110 is also connected to one or more third party databases 130. These third-party databases are databases not specifically associated with any particular jurisdiction, but which still contain relevant data for purposes of authenticating and/or authorizing a particular outside party for communication. Such databases, may include criminal databases, financial databases, court record databases, biometrics databases, etc.

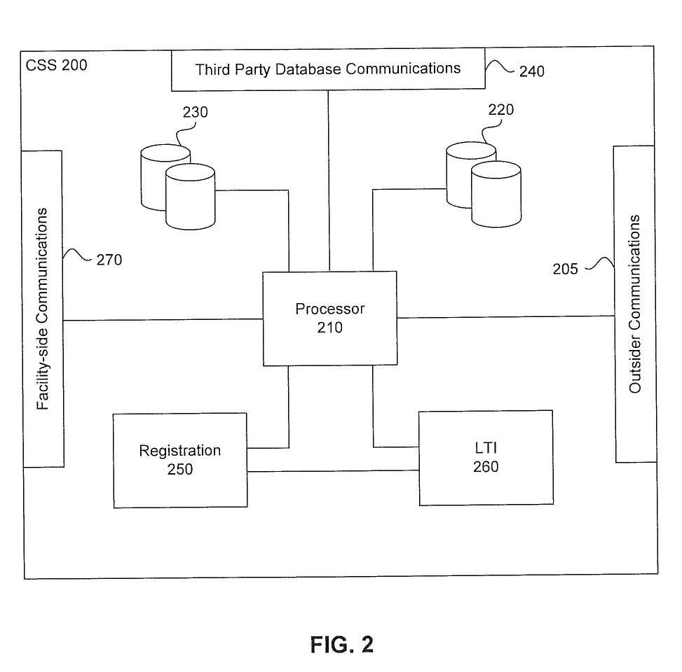

FIG. 2 illustrates a block diagram of an exemplary embodiment of a centralized controlled communication system (CCS) 200. The CCS 200 includes at least one processor 210, registration 250, level of trust indicator (LTI) 260, registration database 220, and criteria database 230, and represents an embodiment of CCS 110.

As discussed above, the CCS 200 is responsible both for carrying out call processing of communications between inmates and outside parties, and also for the registration processing of outside parties prior to the outside parties being able to participate in such communications.

### Registration

There are many ways that the CCS 200 can initiate a registration process for an outside party. First, the CCS 200 can receive a request from the outside party for registration. The processor will utilize IVR to issue a number of prompts to the outside party in order to effectuate the registration process. The prompts will request certain information from the outside party such as identifying information of the calling party, identifying information of the inmate with which the outside party wishes to communicate, and location information of the inmate identifying a facility and/or jurisdiction housing the inmate.

Second, the CCS 200 may process a call to/from the outside party. Through a normal authorization check (discussed later), the CCS 200 determines that the outside party has not been registered with the system. The CCS 200 then initiates the registration process in response to the determination.

Third, the registration process can be initiated by a jurisdiction. For example, when an inmate seeks to add an outside party to their allowed list, the inmate may submit identifying information of the individual for authorization purposes. The jurisdiction forwards the information to the CCS 200, which carries out the registration process based on the information provided and/or contacts the identified individual to carry out the registration process.

During the registration process, the processor 210 receives the requested information via the outsider communications 205. Included within the requested information is identifying information of the outside party and identifying and location information of the inmate with which the outside party wishes to speak. The processor 210 determines the relevant jurisdiction based on the inmate location information. The processor 210 then retrieves authorization criteria from the criteria database 230.

In an embodiment, each jurisdiction transmits authorization criteria to the CCS 200 for storage in the criteria database 230, and for use in registration. The criteria identify the rules, restrictions, or other factors to be considered in determining whether to allow or deny registration of a particular outside party to communicate with a particular inmate of that jurisdiction. Such criteria may be relationship, prior criminal history, financial status, location, etc. In an embodiment, rather than storing criteria received from jurisdictions, the processor 210 can be configured to request current criteria from the jurisdiction for each registration. The criteria can be updated and stored on the databases 145 located within the jurisdictions.

The processor 210 forwards the received outsider and inmate information, as well as the retrieved criteria of the relevant jurisdiction, to registration 250. In some embodiments, processor 210 may also retrieve relevant additional information from the third-party databases 130 via third-party database communications 240. This information is also forwarded to the registration 250. Registration 250 then processes the inmate and outsider information in order to determine whether the outsider can be registered based on the jurisdictional criteria. This process effectively involves determining whether the received inmate and outsider information violates any of the criteria of the inmate's jurisdiction.

In an example, the processor 210 may receive personal identification information and biometric information of the information, as well as a name and housing jurisdiction of the inmate, from the outsider. Using the personal identification information of the outsider, the processor 210 also retrieves a criminal history from a third-party database 130. The processor retrieves the criteria of the identified jurisdiction from the criteria database 230. The processor 210 also communicates with the identified jurisdiction to verify that the identified inmate is, in fact, housed within a facility located in that jurisdiction. Once this determination is made, the processor forwards the retrieved information to the registration 250. Registration 250 verifies that all criteria are satisfied.

In the event that the registration 250 determines that all criteria have been met, the registration 250 notifies the processor 210, which registers the outside party in the registration database 220. Alternatively, if the registration 250 determines that any of the criteria have been violated, registration 250 notifies the processor 210 as to the registration failure. However, in order to maintain a record of the failed registration so as to prevent future registration attempts, processor 210 registers the outside party in n the registration database 220 with a denied flag indicating that the outside party was denied registration for the particular jurisdiction and/or inmate.

In some embodiments, certain criteria may not be able to be determined as satisfied based on a simple review of easily-available information. For example, because of differences in names, and the difficulty of tracking down familial histories, a familial relationship may require a more flexible determination. Another example is biometric information, which may not form a direct match to any previously-stored biometric information, but will have some level of similarity thereto. In such cases, a Level of Trust Indicator (LTI) 260 may be used in order to determine a relative probability that a particular criteria is satisfied. The LTI 260 is configured to perform comparisons, correlations, and other calculations in order to determine a probability that the information satisfies a particular criteria. The LTI 260 forwards the results to the registration 250, which can then factor that information into its registration determination. For example, LTI requirements can be defined by the relevant jurisdictions as part of the criteria, and can be defined on a criteria-specific or general basis. Alternatively, the registration 250 can employ a default LTI requirement. Criteria that meet the defined LTI requirement are considered satisfied, whereas criteria that fail the defined LTI requirement are considered failed.

Although facility communications 270, outsider communications 205, and third party database communications 240 are illustrated separately for ease of discussion, it should be understood that embodiments of the CCS 200 can carry out all communications through a single communications transceiver, or to all end-points (e.g., facilities, third-party databases, and outsiders) via any use of any number of communications transceivers.

### Call Processing

When CCS 200 receives an incoming call, either from or to the outside party, the call is received with certain identifying information of the outside party or CCS 200 requests the information in order to carry out call processing. Such identifying information may include name, telephone number, etc. Processor 210 receives the identifying information and checks the identifying information against the registration database. A first check determines whether the outside party has been registered for the particular jurisdiction/inmate that is party to the call. If the outside party is not registered, then the CCS 200 carries out the registration process, as described above.

If the processor 201 determines that the outside party has been registered for the particular jurisdiction/inmate that is party to the call, then the processor 201 determines whether that registration was approved or denied. If the registration was denied, then the call is terminated. On the other hand, if the registration was approved, then the call is permitted to proceed and the processor 201 connects the call to the desired recipient. The processor 201 can check the registration database in a variety of different ways. For example, the registration database 220 can be set up according to outside party identity, in which case the processor 201 accesses a record associated with the outside party, and determines whether they are authorized for communication with the particular jurisdiction/inmate. In an alternate configuration, the registration database 220 can be set up according to inmate. Thus, when a call is processed, the processor 201 accesses the registration database 220 based on the inmate information, and determines whether the outside party is an authorized party within the inmate record.

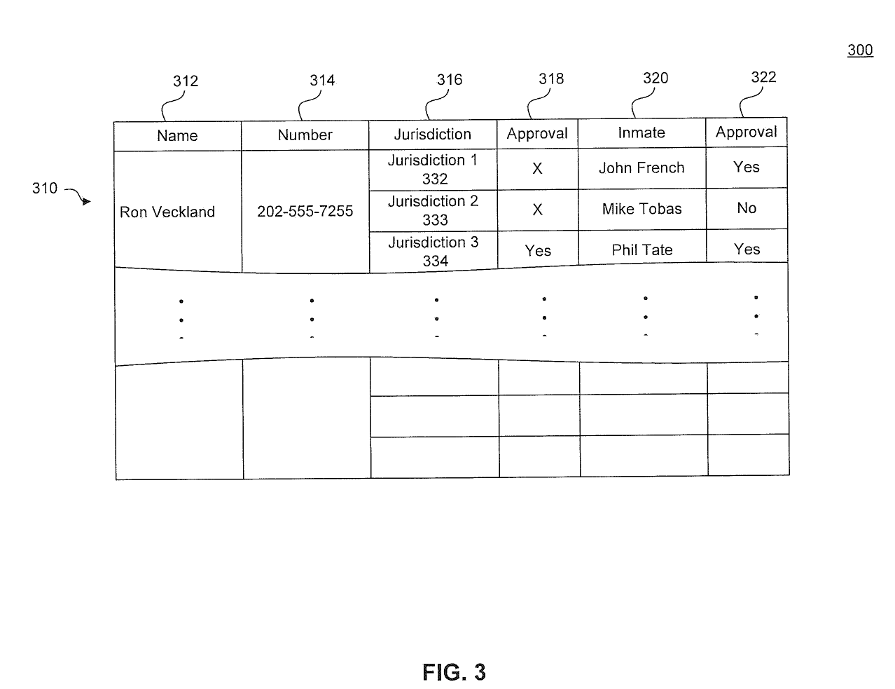

FIG. 3 illustrates an exemplary database structure 300 of a registration database 220 according to an embodiment of the present disclosure. The database structure 300 is comprised of a plurality of data records 310. In the example of FIG. 3, each data record 310 corresponds to a particular outside party. However, as discussed above, in other embodiments the data structure 300 may include data records 310 corresponding to different inmates, or even jurisdictions.

In the example of FIG. 3, each data record 310 includes a plurality of data entries 312-322. Such data records include a name 312 of the outside party, other identifying information of the outside party 314 (e.g., telephone number), jurisdictions 316 for which the outside party has undergone at least one registration, jurisdictional approval 318, inmates 320 of the jurisdiction for which the outside party has undergone registration, and inmate approvals 322.

For example, as shown in FIG. 3, a particular inmate, Ron Vecklan, is stored in association with certain identifying information, such as a telephone number 314. The identifying information 314 can include any number of entries, and may include other types of identifying information, such as address, location, biometric information, etc. Associated with the outside party are all jurisdictions for which the outside party has undergone a registration. As shown in FIG. 3, the outside party 310 is associated with three jurisdictions, jurisdictions 1-3. As discussed above, any of the jurisdictions can instead identify a particular facility instead of a jurisdiction.

In some instances, the outside party may be authorized for communication to the jurisdiction in general, rather than a particular inmate within the jurisdiction. The jurisdiction approval 318 identifies whether such jurisdiction-wide approval exists for that outside party. When no such approval has been given, the entry 318 is empty. Otherwise, the entry 318 is flagged appropriately, as with regard to jurisdiction 3 336.

Within the institutions that do not have jurisdictional approval, such as for jurisdictions 1 332 and jurisdiction 2 334, entry 320 includes a listing of all inmates within the jurisdiction for which an approval has been carried out. Entry 322 includes an approval for each of the inmates.

When the processor 210 accesses the database and identifies the relevant data record 310, the processor 210 checks whether the jurisdiction of the inmate is listed in the data record. If not, then the processor 210 initiates a registration process for the jurisdiction and/or inmate. Alternatively, the processor 210 determines that the jurisdiction is listed, and then proceeds to check whether the outside party is successfully registered for communicating with the inmate. In order to make this determination, the processor 210 checks to see whether the outside party has jurisdictional approval, and if not, whether the inmate is listed in the data record 310. If listed, the processor 210 checks whether the registration was approved in entry 322. If not listed, then the processor 210 starts the registration process.

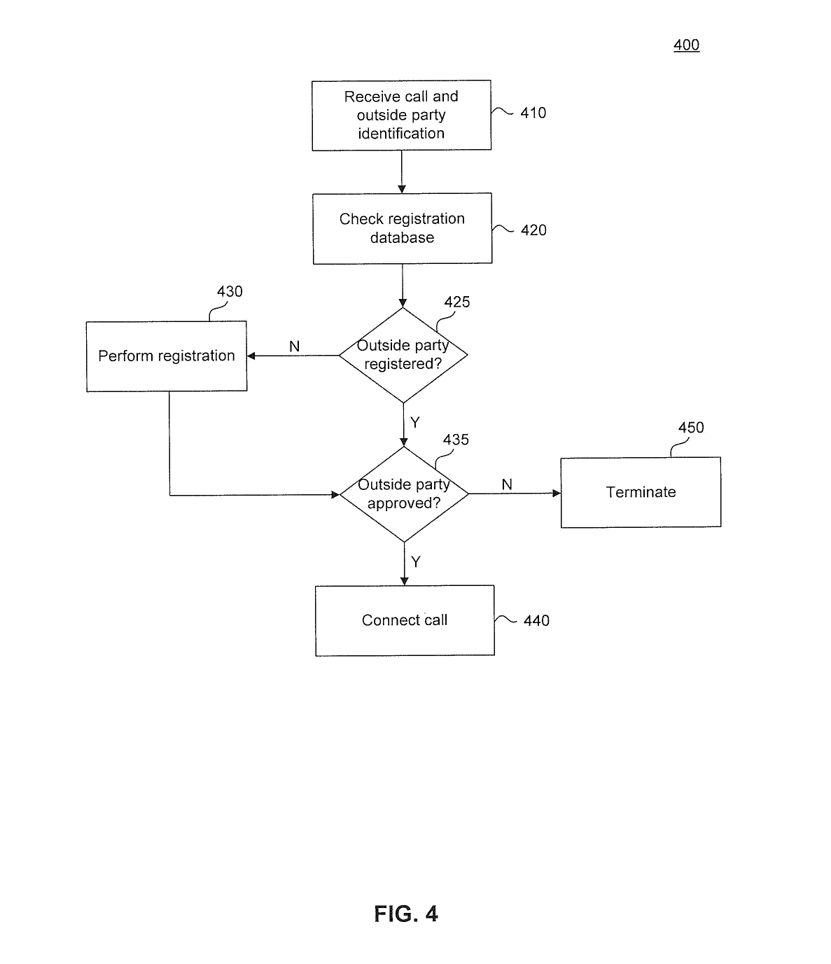

FIG. 4 illustrates a flowchart diagram of an exemplary method 400 for processing a call according to an exemplary embodiment of the present disclosure. It should be understood that a “call” can refer to any live communication between the inmate and the outside party, including a telephone call, instant messaging, email, video call, etc. In the method, the call is received 410 along with an identification of the outside party. In an embodiment, the outside party is identified by either the originating or destination telephone number. Using the identification information of the outside party, the system checks a registration database 420.

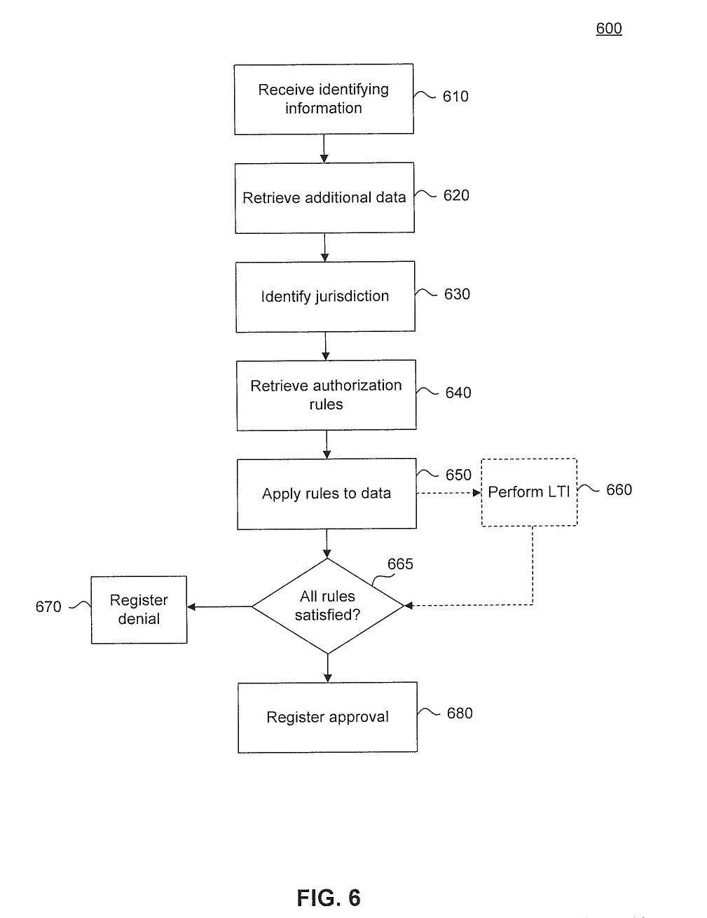

The system first checks to determine whether the outside party has been registered 425. Specifically, the system searches the registration database for a data record associated with the outside party. If the outside party has not been registered (425—N), then the system performs a registration procedure 430 with respect to the outside party, which is discussed in detail with respect to FIG. 6.

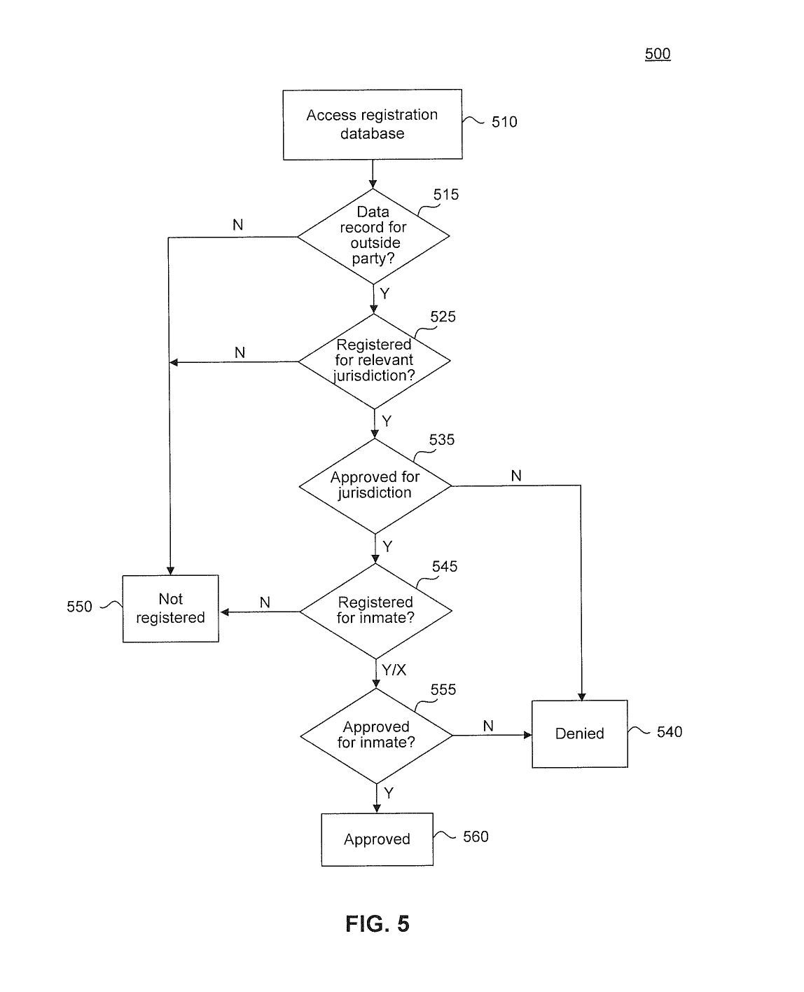

If the outside party has been registered (425—Y), or after registration 430, the system then makes a determination as to whether the outside party is approved for the call 435. This determination can be jurisdiction, institution, or inmate specific, and is discussed in further detail with respect to FIG. 5. If the outside party is not approved (435—N), then the call is terminated 450. In an embodiment, the call is not permitted to be connected until after the system has determined that the outside party is approved. In another embodiment, the call proceeds until the approval or disapproval is determined, at which time the call is terminated. On the other hand, if the system determines that the outside party is approved (435—Y), then the system connects the call 440.

FIG. 5 illustrates a flowchart diagram of an exemplary method 500 for determining whether an outside party is approved for the particular communication, according to an embodiment of the present disclosure. In the method 500, the system first accesses the registration database 510. Using the identification information of the outside party, the system then determines whether there exists in the registration database a data record associated with the outside party 520. If there is no data record (515—N), then the outside party has not yet been registered 550. Any instance of the method determining that the outside party is not registered, then a registration process is initiated, as discussed with respect to FIG. 6.

If, on the other hand, there is a data record associated with the outside party (515—Y), then the system determines whether the outside party has been registered for the relevant jurisdiction 525 associated with the inmate. This determination can be made based on whether the specific jurisdiction is listed in the data record of the outside party. If the outside party has not been registered for the jurisdiction (525—N), then the system determines that the outside party is not registered 550.

If, on the other hand, the outside party is registered (525—Y), then they system makes a determination as to whether the outside party is approved for the jurisdiction. Specifically, even if the registered, the registration for the jurisdiction may indicate that the outside party was not approved for the jurisdiction. In this case (535—N), the outside party is denied access to the communication 540. If the outside party is approved (535—Y/X), or registered without an indication of general approval for the jurisdiction, then the system determines whether the outside party is registered for the specific inmate 545. This determination can be made based on whether the inmate is identified in the data record associated with the outside party.

If the outside party is not registered for the inmate (545—N), the system identifies the outside party as not registered 550. If, on the other hand, the outside party is registered for the inmate (545—Y), then a determination is made as to whether the outside party is approved for the inmate 555. If the outside party is identified in the data record as being not approved for the inmate (555—N), then the communication is denied 540. Otherwise, if the outside party is approved for the inmate (555—Y), then the communication is approved 560.

FIG. 6 illustrates an exemplary method 600 for carrying out a registration of an outside party according to an embodiment of the disclosure. First, the system receives identifying information 610 of the outside party. Using the identifying information, the system retrieves additional information 620 relating to the outside party. Such information can include information from local, jurisdictional, or third-party databases, and may include criminal records, financial records, etc. The method next identifies a relevant jurisdiction for which to register the outside party 630. The jurisdiction can be determined based on an inmate associated with the communication or identified by the outside party.

Once the jurisdiction has been identified, the system retrieves authorization rules associated with the jurisdiction 640. The system then applies the authorization rules to the information associated with the outside party 650. In some embodiments, one or more rules may require LTI to be performed 660 in order to determine a relatively certainty that a given rule has been satisfied. Based on the rules application 650 and/or the LTI 660, the system then determines whether all rules associated with the jurisdiction have been satisfied 665. If any rules is not satisfied (665—N), then the system registers a denial with respect to the inmate and the jurisdiction for the outside party in the registration database. If, on the other hand, all rules are satisfied (665—Y), then the system registered an approval with respect to inmate and the jurisdiction for the inmate.

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

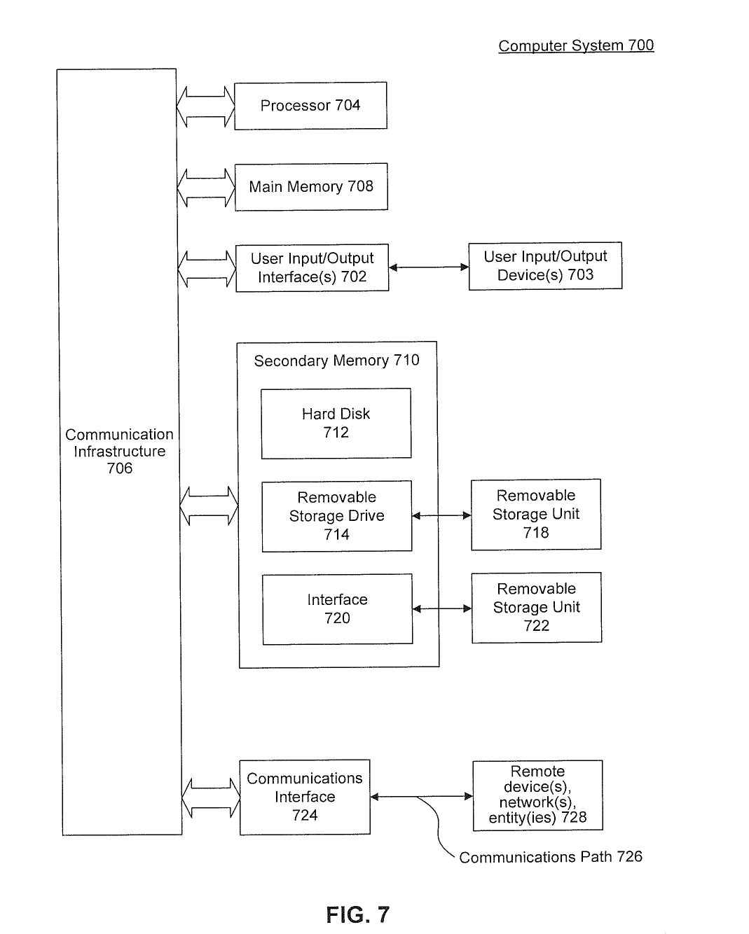

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the methods of FIGS. 4-6 can be implemented in the environment of one or more computer systems or other processing systems. An example of such a computer system is shown in FIG. 7. One or more of the modules depicted in the previous figures can be at least partially implemented on one or more distinct computer systems 700.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, and the like. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the invention should not be limited by any of the above-described exemplary embodiments, but should be defined only in accordance with the following claims and their equivalents.

1-7. (canceled)

8. A method for processing a communication between an inmate of a controlled environment facility within a jurisdiction and an outside party, the method comprising:
receiving the communication from the inmate;
identifying a jurisdiction of the inmate from the received communication;
receiving identifying information of the outside party;
accessing a registration database;
determining, based on the identifying information, whether the outside party is registered in the registration database; and
assessing whether the outside party is authorized to communicate with the inmate based on the jurisdiction of the inmate;
connect or terminate the communication based on the assessing.

9. The method of claim 8, wherein the determining includes:
locating a data record in the registration database associated with the outside party; and
determining whether the data record includes a listing for the jurisdiction.

10. The method of claim 9, wherein the determining further includes determining whether the data record includes a listing for the inmate.

11. The method of claim 9, wherein the assessing includes first determining whether the outside party has jurisdiction-wide authorization, such that the outside party is permitted to communicate with any inmate from within the jurisdiction of the inmate, and second determining, in response to the outside party not having jurisdiction-wide authorization, whether the outside party is specifically authorized to communicate with the inmate.

12. The method of claim 9, wherein the determining whether the outside party is registered includes determining whether the listing for the jurisdiction includes a listing for the inmate.

13. The method of claim 12, wherein the assessing further includes determining whether the listing for the inmate indicates that the outside party is authorized for the inmate.

14. A method of processing a communication between an inmate and an outside party, the method comprising:
receiving a communication from one of the inmate or the outside party designated for the other of the inmate or the outside party;
identifying a jurisdiction of the inmate;
identifying the outside party based on the received communication;
accessing a registration database;
determining that the registration database includes a data record associated with the outside party;
complete or terminate the communication based on whether the outside party is authorized to communicate with at least one of the jurisdiction or the inmate.

15. The method of claim 14, further comprising determining whether the data record includes a data entry associated with a jurisdiction within which the inmate is located.

16. The method of claim 15, further comprising determining whether the data record includes a data entry associated with the inmate.

17. The method of claim 14, further comprising first determining whether the outside party has jurisdiction-wide authorization, such that the outside party is permitted to communicate with any inmate from within the jurisdiction of the inmate, and second determining, in response to the outside party not having jurisdiction-wide authorization, whether the outside party is specifically authorized to communicate with the inmate.

18. The method of claim 17, wherein the call is completed upon determining that the outside party is approved for the jurisdiction, and
wherein the call is terminated upon determining that the outside party is not approved for the jurisdiction.

19. The method of claim 16, further comprising determining whether the data entry associated with the inmate includes an indication that the outside party is approved for the inmate.

20. The method of claim 19, wherein the call is completed upon determining that the outside party is approved for the inmate, and
wherein the call is terminated upon determining that the outside party is not approved for the inmate.

21. A method for processing a communication between an inmate of a controlled environment facility within a jurisdiction and an outside party, the method comprising:
receiving the communication;
identifying a jurisdiction of the inmate from the received communication;
receiving identifying information of the outside party;
accessing a registration database;
determining, based on the identifying information, whether the outside party is registered in the registration database with respect to the jurisdiction;
assessing whether the outside party is authorized to communicate with the inmate based on whether the outside party is registered with respect to the jurisdiction; and
connect or terminate the communication based on the assessing.

22. The method of claim 21, further comprising:
receiving identifying information of the inmate; and
determine the jurisdiction based on the identifying information of the inmate,
wherein the assessing includes first determining whether the outside party has jurisdiction-wide authorization, such that the outside party is permitted to communicate with any inmate from within the jurisdiction of the inmate, and second determining, in response to the outside party not having jurisdiction-wide authorization, whether the outside party is specifically authorized to communicate with the inmate.

23. The method of claim 22, further comprising:
retrieving registration rules from the registration database associated with the jurisdiction, wherein the registration rules are criteria that must be satisfied by the outside party in order to register with the jurisdiction.

24. The method of claim 23, wherein the criteria include relationship to the inmate, prior criminal history, financial status, and location.

25. The method of claim 23, further comprising retrieving additional outside party information from a third-party database,
wherein the additional outside party information includes criminal a criminal history of the outside party.

26. The method of claim 23, further comprising determining that the outside party satisfies all of the registration rules; and
approving the outside party for communication with the inmate in response to the determining.

27. The method of claim 23, further comprising:
determining that the outside party does not fully satisfy at least one of the registration rules; and
calculating a level of trust indicator for the at least one of the registration rules, the level of trust indicator specifying a relative likelihood that the at least one of the registration rules is satisfied.
